(19) United States
(12) Patent Application Publication
(10) Pub. No.: US 2022/0301072 A1
(43) Pub. Date: Sep. 22, 2022

(54) SYSTEMS AND METHODS FOR PROCESSING CLAIMS

(71) Applicant: DataInfoCom USA, Inc, Austin, TX (US)

(72) Inventors: Wensu Wang, Katy, TX (US); Yuhao Sun, Plano, TX (US)

(21) Appl. No.: 17/837,017

(22) Filed: Jun. 9, 2022

Related U.S. Application Data
(63) Continuation-in-part of application No. 17/063,661, filed on Oct. 5, 2020.
Application No. 17/063,661 is a continuation-in-part of application No. 16/732,281, filed on Dec. 31, 2019.
Application No. 16/732,281 is a continuation-in-part of application No. 17/491,361, filed on Sep. 30, 2021.
(60) Provisional application No. 62/976,191, filed on Feb. 13, 2020.
(60) Provisional application No. 63/085,963, filed on Sep. 30, 2020.

(51) Int. Cl. G06Q 40/08; G06F 40/40; G06F 16/33

(52) U.S. Cl. CPC G06Q 40/08; G06F 40/40; G06F 16/3347

(57) ABSTRACT

Methods, systems, and apparatuses, including computer programs encoded on computer storage media, are provided for processing claims using both unstructured and structured policy documents, claim data, and customer and policy data, in conjunction with automatic requests for human intervention. Policy rules, benefit calculation formulae, necessary data points, and benefit requirements are extracted from policy documents using NLP and AI techniques. Unstructured claim data is converted to a structured form using natural language processing, information extraction, and AI techniques to identify and extract relevant information, including values for the data points and benefit conditions, then the combined structured data and converted unstructured data is processed to get all values for the data points and applicable benefit conditions. The relevant claim information is then further processed against the policy rules for eligibility assessment and benefit calculation formulae to generate a benefit payment amount and entitled additional benefits.

### CROSS-REFERENCE TO RELATED APPLICATIONS

The present application is a continuation-in-part of U.S. patent application Ser. No. 17/063,661, entitled “SYSTEMS AND METHODS FOR PROCESSING CLAIMS,” filed Oct. 5, 2020, which is a continuation-in-part of U.S. patent application Ser. No. 16/732,281, entitled “SYSTEMS AND METHODS FOR CLAIMS PROCESSING,” filed Dec. 31, 2019, and claims the benefit of U.S. Provisional Patent Application No. 62/976,191, filed Feb. 13, 2020, and is a continuation-in-part of U.S. patent application Ser. No. 17/491,361, entitled “SYSTEMS AND METHODS FOR INFORMATION RETRIEVAL AND EXTRACTION,” filed Sep. 30, 2021, which claims the benefit of U.S. Provisional Patent Application No. 63/085,963, filed Sep. 30, 2020, each of which is hereby incorporated by reference herein in its entirety.

### BACKGROUND

The present application relates to the use of natural language processing techniques and other artificial intelligence technologies, in conjunction with human intervention when necessary, in the processing of claims made pursuant to a policy, such as an insurance policy, terms and conditions, or a benefit calculation formula. More specifically, the present application relates to the processing of claims using all available structured and unstructured data related to each claim together with policy data sources (structured or unstructured), and to make determinations related to the processing of each claim. This specification also relates generally to extracting information from documents, either claim or policy documents, and more specifically to using image processing, natural language processing, and artificial intelligence techniques to convert any type of document to a computer-readable form (e.g., text) and extract needed information for claim processing from it, with quantifiable metrics used to decide when human intervention is needed to ensure accuracy.

Many current procedures related to the processing of claims, e.g., insurance claims (such as, but not limited to, claims on workers' compensation, income protection, life insurance, trauma insurance, total and permanent disability, property and casualty, etc.), warranty claims, rebate claims, item return claims, credit card claims (such as, but not limited to, price protection, extended warranty, etc.), etc., require significant manual effort. As such, these procedures are prone to extensive and expensive errors. There remains a need for methods that can automatically, more accurately, and with more transparency, process claims of any type using all the available documents, extract needed information from the available documents, and assess eligibility for applicable policy benefits.

### SUMMARY

In accordance with the foregoing objectives and others, exemplary methods and systems are disclosed herein for processing claims using both unstructured and structured policy data, terms and conditions data, and/or claim data. Policy rules, terms and conditions, benefit calculation formulae, necessary data points, and benefit requirements are identified and extracted from policy and other documents using natural language processing (NLP), information extraction, image processing including optical character recognition (OCR), machine learning/deep learning models, and other related AI techniques. Similarly, unstructured claim data, including claim documents, is converted to a structured form including values for the data points and benefit requirements, then the combined structured data and converted unstructured data is processed to determine values for the data points and applicable benefit conditions identified from policies. The relevant claim information is further processed according to the policy rules, terms and conditions, and/or benefit calculation formulae to determine a benefit payment amount and/or additional benefits.

One embodiment relates to a method for analyzing a claim made by a claimant, the method comprising: receiving claimant information, claim information, at least one claim document, and at least one policy document from a CMS; extracting at least one policy rule from the at least one policy document; determining at least one claim variable based on the at least one policy rule; identifying at least one claim document likely to have information relevant to the at least one claim variable; extracting the relevant information from the at least one claim document; determining a value for the at least one claim variable based on the extracted information; assessing if the claimant is entitled to the claim based on the determined value for the at least one claim variable; calculating a benefit due the claimant; and notifying the CMS of the claim assessment and calculated claim benefit.

Another embodiment relates to a system comprising one or more processors and one or more storage devices storing instructions that when executed by the one or more processors cause the one or more processors to perform operations comprising: receiving claimant information, claim information, at least one claim document, and at least one policy document from a CMS; extracting at least one policy rule from the at least one policy document; determining at least one claim variable based on the at least one policy rule; identifying at least one claim document likely to have information relevant to the at least one claim variable; extracting the relevant information from the at least one claim document; determining a value for the at least one claim variable based on the extracted information; assessing if the claimant is entitled to the claim based on the determined value for the at least one claim variable; calculating a benefit due the claimant; and notifying the CMS of the claim assessment and calculated claim benefit.

An additional embodiment relates to a computer program product encoded on one or more non-transitory computer storage media, the computer program product comprising instructions that when executed by one or more processing means cause the one or more processing means to perform operations comprising: receiving claimant information, claim information, at least one claim document, and at least one policy document from a CMS; extracting at least one policy rule from the at least one policy document; determining at least one claim variable based on the at least one policy rule; identifying at least one claim document likely to have information relevant to the at least one claim variable; extracting the relevant information from the at least one claim document; determining a value for the at least one claim variable based on the extracted information; assessing if the claimant is entitled to the claim based on the determined value for the at least one claim variable; calculating a benefit due the claimant; and notifying the CMS of the claim assessment and calculated claim benefit.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of one example of a claim processing system.

FIG. 2 is a schematic illustration of one example of a claim management system.

FIG. 2 illustrates an example end-to-end method for automatically processing and paying a claimed benefit.

FIG. 3 illustrates a different versions of policy documents for a particular policy.

FIG. 4 illustrates an example method for receiving and processing claim type information.

FIG. 6 illustrates an example method for receiving and processing claim data point information.

FIG. 7 illustrates an example method for the calculation of pre-disability income (PDI).

FIG. 8 illustrates an example method for information retrieval.

FIG. 9 illustrates an example method for converting images of text (either handwritten or machine-typed) into text.

FIG. 10 illustrates an example method for extracting policy rules from policy documents.

FIG. 11 illustrates an example claim summary screen for claim management.

FIG. 12 illustrates an example claim drill down screen for claim management.

FIG. 13 illustrates an example method for information retrieval using a question and answer system.

FIG. 14 is a schematic illustration of one example of a distributed claim processing system.

FIG. 15 illustrates an example method for converting hybrid type-written and handwritten documents to text.

FIG. 16 illustrates an example method for extracting data from a document.

FIG. 17 illustrates an example method for extracting date information from a document.

FIG. 18 illustrates an example method for extracting medical information from a document.

FIG. 19 illustrates another example method for extracting medical information from a document.

FIG. 20 is a schematic diagram of an example computing system for any of the systems described herein.

### DETAILED DESCRIPTION

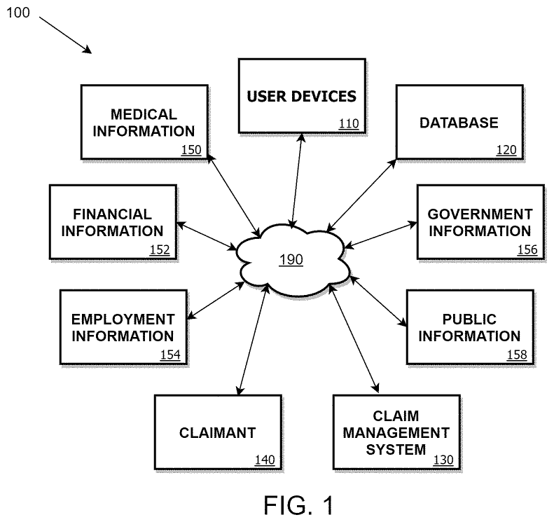

Embodiments of the present disclosure are best understood by referring to FIGS. 1-20 of the drawings, like numerals being used for like and corresponding parts of the various drawings.

Referring to FIG. 1, a block diagram of an exemplary system 100 for use in processing claims is illustrated. The claim processing system may include user devices 110, a database 120 which stores both structured and unstructured data, a claim management system 130, and may receive input from a claimant system or device 140 and/or one or more third party information sources (150, 152, 154, 156, 158), including medical information sources 150 (e.g., doctors' offices, hospitals, etc.), financial information sources 152 (e.g., credit bureaus, tax agencies, etc.), employment information sources 154 (e.g., the claimant's employer or former employer, etc., which can provide business statements, paystubs, invoices, etc.), government information sources 156 (e.g., tax bureaus, etc.), and public information sources 158 (e.g., public media websites, etc.). The user devices, database, claim management system, claimant device, and third party information sources may be remote from each other and interact through a communication network 190. Non-limiting examples of communication networks include local area networks (LANs), wide area networks (WANs) (e.g., the Internet), etc.

In certain embodiments, a user, such as a case manager, may access the claim management system 130 and/or the database 120 via a user device 110 connected to the network 190. A user device 110 may be any computer device capable of accessing any of the claim management system or the database, such as by running a client application or other software, like a web browser or web-browser-like application.

The database 120 is adapted to receive, determine, record, transmit, and/or merge information for any number of policies, policy documents, terms and condition documents, policyholders, customers, claims, claim documents, inquiries, potential contacts, and/or individuals. The database 120 may store both unstructured and structured data, including structured information from a policy administration system database and formerly unstructured data that has been converted to structured data, e.g., structured data extracted from policy documents, terms and condition documents, claim documents, etc.

The claim management system 130 is adapted to receive claim data from claimant 140 and/or third party information sources (150, 152, 154, 156, 158), process received claims based on policy documents, terms and condition documents, policy rules, and received claim data, and make claim payments to claimants.

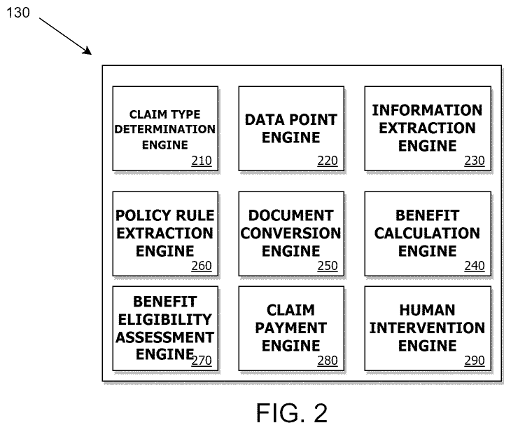

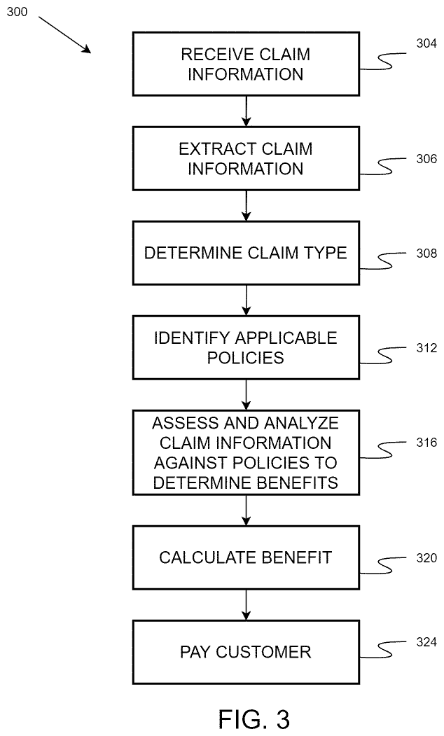

FIG. 2 is a more detailed schematic illustration of one example of a claim management system 130. As illustrated, the claim management engine may include a claim type determination engine 210, a data point engine 220, an information extraction engine 230, a benefit calculation engine 240, a document conversion engine 250, a policy rule extraction engine 260, a benefit eligibility assessment engine 270, a claim payment engine 280, and a human intervention engine 290. These engines are configured to communicate with each other to manage the entire process of claim management, from the initial receipt of a claim to the payment of the claim.

The rest of this disclosure describes a particular implementation related to workers' compensation, disability, and/or income protection benefits, but the same principles and processes apply to the processing and management of other types of claims. For instance, the same processes may be used to calculate claims made with respect to other types of insurance policies, e.g., life/death insurance, trauma insurance, total and permanent disability, and property and casualty (e.g., auto and home) policies. Additionally, the same processes may be used to calculate other types of claims made under a terms and conditions document, e.g., credit card terms (for charge backs, price protection, extended warranties, trip cancellation, etc.), warranties, item returns, rebates, etc.

Claim type determination engine 210 is configured to use the initial claim information received by the system (e.g., the initial information from the claimant) to determine the type of benefit claim, e.g., life/death insurance, disability insurance, etc. The claim type determination engine may comprise a trained prediction model, such as an artificial neural network (ANN), a knowledge-based model, or a mixed type of model. If using a trained prediction model, the model will have been trained on some historical claim information that has been labeled to identify the claim type of each claim. If there is not enough information to make a determination, a flag will be automatically generated to signal that human intervention is needed.

Policy rule extraction engine 260 is configured to extract definitions and/or rules from insurance policy and/or terms and conditions documents and/or policy benefits. The extracted rules may include benefit conditions, such as that the claimant be under medical care, that the claimant is unable to work in his or her primary occupation, that the claimant's condition be caused by a sickness or injury, etc. The definitions and rules may include some data points by which to assess them.

The extracted rules may also include benefit calculation formula(e), as well as data points necessary for the calculation of any formula. For example, a disability benefit calculation may require the claimant's pre-disability income, among other data points. The rules extracted from the policy document will include a list of all of the data points that are required to determine eligibilities and benefits as well as to calculate the benefit amount.

Data point engine 220 is configured to determine values for the data points needed for the applicable benefit calculation formula(e) and the data points needed to determine eligibility for benefits. The data point engine can determine which conditions and/or data points have values (e.g., as extracted from the initial claim information submitted by the claimant, input by the case manager, etc.) and, for those that are unassigned, work with the document conversion engine 250 and information extraction engine 230 to gather the needed information from documents relevant to the claim using NLP or other AI techniques.

For each data point, the data point engine keeps a list of the types of documents that may contain the needed information. The data point engine can check to see if any of the relevant documents have been loaded in the system (e.g., are associated with the claim in the database), and if so, have the document(s) processed by the document conversion engine 250 and information extraction engine 230. If no relevant documents are available, the data point engine can notify the case manager that further documentation is required. All calculated data points, historical and current, are saved by the data point engine. Corrected data points, either by human intervention or by recalculation based on new claim information, are also saved.

In cases where the data point engine 220 is unable to determine a value for a data point, the human intervention engine 290 may be invoked to notify the case manager that calculation of the value for that data point requires manual intervention. The human intervention engine is configured to receive the needed input and supply it to the data point engine.

Benefit eligibility assessment engine 270 is configured to assess if a claim is eligible for the claimed benefits by comparing the determined terms and conditions of the applicable policy against extracted claim data. This engine works with the data point engine 220 to extract the required data points from the available claim documents, and then determines values for the benefit conditions (e.g., the condition is met (true) or not met (false)).

Document conversion engine 250 is configured to convert documents into a form that is interpretable by the information extraction engine. In an embodiment, all documents are converted, through one or more processes, to text format. For example, a pdf document may be converted to text by extracting the embedded text directly and/or using optical character recognition (OCR) techniques after first converting it to images. Similarly, a scanned machine-typed image may be converted to text using OCR techniques or other image processing as well as AI techniques.

Handwritten documents can also be converted to text using a handwriting recognition tool with deep learning and/or machine learning techniques, such as one or more trained neural networks. For documents containing both machine-typed portions and handwritten portions, the machine-typed and handwritten contents may be divided into segments, and then separately processed using the techniques outlined herein. An integrated OCR API can be used to recognize all types of text in an image and convert to text.

In all document conversion techniques for documents with a visual aspect (e.g., images, pdf files, scanned document, word processing document, etc.), the positional relationships of the converted segments with respect to the document page are maintained, e.g., using x and y coordinates on the document page. This retains useful context information, which can be used by the information extraction engine 230.

Documents converted by the document conversion engine also include audio and video files, e.g., audio recordings of phone calls, video recordings of video calls, video chats, etc. Such calls may be between parties relevant to the claim, e.g., the claimant, doctors, employers, etc. After documents are converted, relevant information can be extracted by the information extraction engine 230.

Information extraction engine 230 uses natural language processing (NLP) techniques to extract the required information from the (original or converted) text documents. Such techniques may include text normalization (e.g., converting to a consistent case, removing stop words, lemmatizing, stemming, etc.), keyword recognition, part of speech tagging, named entity recognition (NER), sentence parsing, regular expression searching, word chunk searching (e.g., using a context-free grammar (CFG)), similarity searching (e.g., with word/sentence embedding), machine learning models, transfer learning, question and answering systems etc.

Benefit calculation engine 240 is configured to calculate the benefit due to the claimant based on the benefit calculation rules, including calculation formula(e) or a defined value etc., extracted by the policy rule extraction engine 260 and the data points determined by the data point engine 220. For disability insurance, calculated benefits may include basic benefits, ancillary benefits, and/or options amounts, and may be calculated based on one or more of the pre-disability income, the total disability benefit of the policy, current partial disability income, and any offset amount.

In an embodiment, the benefit calculation engine may use the benefit eligibility assessment engine 270 to first assess whether any required benefit conditions are met (e.g., the claimant must be under medical care). If the benefit conditions are met, then the benefit calculation engine can calculate the benefit amount using the data points.

The benefit calculation engine may comprise a web-based (or other type of) interface through which a case manager (or other user) may view the formula used, the data points that are inputs to the formula, any supporting documents the data points are extracted from, and the amount calculated. Through this interface, the case manager may be notified of certain conditions, e.g., data point engine 220 cannot calculate a necessary data point, an exception is encountered (e.g., necessary medical or financial information to assess a claim's benefit type or calculate the benefit amount is missing, a handwritten document cannot be converted to text, etc.), a calculation requires verification (e.g., certain pre-disability income calculations, complex cases that require specific domain knowledge), an action needs to be taken (e.g., a claim payment is due in X days, a waiting period is due in Y days, etc.), etc. In an embodiment, the interface may also enable the case manager to approve the payment to the claimant. Alternatively, the payment may be processed automatically.

Claim payment engine 280 is configured to process and make payments to claimants based on payment amounts calculated by the benefit calculation engine 240. The claim payment engine may also be configured to perform additional functionality, such as setting up alternative payment plans and reconciliation. Alternative payment plans would include deviating the actual payment to the customer from the calculated amounts based on presently available supporting documents and policies and conditions. For example, if a customer has an urgent situation that needs the payment to be issued immediately, an agreement may be made to release the payment prior to when the actual supporting documents and evidence are available. Later, when the customer submits the supporting documents, the payment amount will be re-calculated based on the documents and the already released payment would be subtracted from the new payment.

With respect to reconciliation, the claim payment engine can be configured to, at the end of each fiscal year, perform an integrated check of all payments issued in the preview year (e.g., 12 months). This check can compare the previous year's payments with the yearly-based accounting results. If there is any discrepancy, a case manager may be notified.

Modifications, additions, or omissions may be made to the above systems without departing from the scope of the disclosure. Furthermore, one or more components of the systems may be separated, combined, and/or eliminated. Additionally, any system may have fewer (or more) components and/or engines. Furthermore, one or more actions performed by a component/engine of a system may be described herein as being performed by the respective system. In such an example, the respective system may be using that particular component/engine to perform the action.

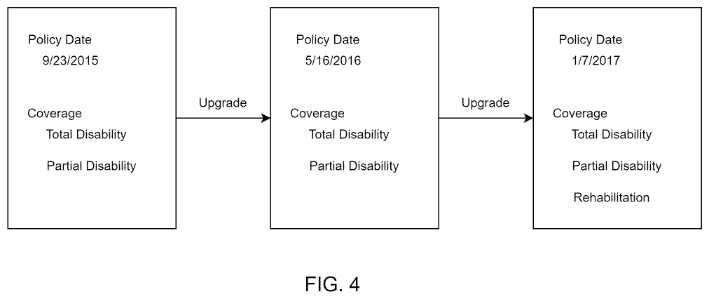

FIG. 3 illustrates an example method 300 for automatically processing and paying a claimed benefit end-to-end, such as may be performed by the claim management system 130. Such benefits may be based on an insurance policy or investment vehicle, e.g., income protection insurance, total and permanent disability insurance, trauma and/or life insurance, etc. In one embodiment, the disclosed automatic solution for benefit processing comprises several processes, including: receiving of claim information, collection of claims-related documents, identification of the claim type, retrieval and/or creation of the rules applicable to the identified claim type (e.g., based on policy documents), retrieval of information from the collected documents, assessment of claim information against the policy to determine eligibility and benefits, benefit calculation based on the rules and claim information, and benefit payments. One or more AI models, including NLP models, may be used by each component to automate claim type identification, rules creation and/or retrieval, information recognition, collection, and extraction, calculations, payments, and any necessary reviews.

In step 304, claim information is received. Such information may include unstructured data and structured data in various formats. Unstructured data may include text documents (e.g., paper or electronic claim forms, claim notes, medical reports, claimant financials, etc.), images (e.g., of injuries), audio recordings (e.g., of a phone conversation with the claimant), etc. The unstructured claim information is converted to a machine-readable format if necessary (e.g., paper documents are scanned), then processed to extract applicable information in step 306. Claim information may also be received in structured formats, e.g., information retrieved from a customer database.

Claim data may include policyholder variables (e.g., personal data, financial data, asset data, claim history data, employment data, etc.) for the relevant policy, policy data for the relevant policies, and data related to the current claim and claimant. Policyholder variables may also include policy deductibles, policy discounts, policy limits, premium development history, and the policyholder's credit score or other information regarding the policyholder's financial status or history. The policy variables may include all information relating to the policy, e.g., type, term, effective data, coverages, etc.

The claimant variables may include all information relating to the claimant, e.g., identity of the claimant, indemnity payouts, submitted bills, medical history, prior claim history, prior injury history, etc.

The claim variables may include all information relating to the claim, e.g., identity of the claimant and the insured, claim status, claim history, claim payouts, submitted medical bills, and any other information relevant to the claim.

In step 308, the claim type is determined from the claim information as discussed with respect to claim type determination engine 210. A trained AI model may be used to determine the claim type. Such a model may have been trained using some historical claim data and corresponding historical claim types, using known techniques.

In step 312, one or more applicable policies are identified based on the claim information and the claim type. The claim management system 130 keeps a correspondence between claimants, claim types, policy effective dates, and policies in an appropriate data store, e.g., one or more database tables in database 120. Relevant inputs (e.g., claimant ID, claim type, date of occurrence, insurance schedule, etc.) may be used to query the database or otherwise identify applicable documents, which may include policies, optional benefits, ancillary benefits, updates or upgrades, etc. The system may store multiple versions of policy documents for each policy to provide for policy upgrades.

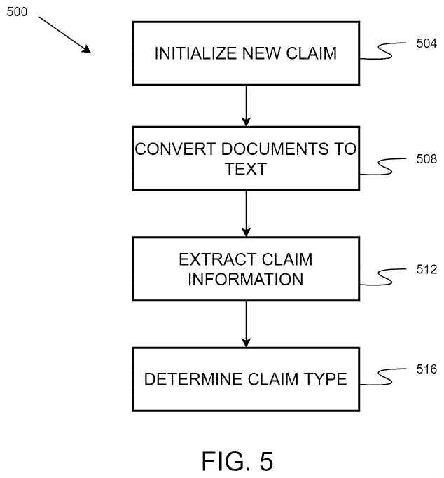

FIG. 4 is an illustration of upgrades and/or other versions of policy documents for a particular policy, including the types of benefits that each policy document covers. As shown, the illustrated policy started on Sep. 23, 2015, and there were version changes on May 16, 2016; and Jan. 7, 2017. Each of the policy versions includes provisions related to partial disability and total disability. The Jan. 7, 2017 version also includes a provision related to rehabilitation expenses. Policy information, such as policy start and/or upgrade dates, applicable policy provisions, and policy document identifiers (which reference the actual policy documents) may be stored in a structured manner in database 120.

In an embodiment, for a policy with multiple versions (e.g., upgrades or version changes), the benefit amount is calculated with respect to each policy version between the policy commencement date and the claim occurrence date, and the most favorable version is applied to the policyholder if required.

After the policy or policies are identified, unstructured information regarding the policy or policies is retrieved from the database and document management system. The information may include original benefit documents, including policies, policy options, ancillary benefits, policy upgrades, version changes, etc. Policy benefit rules are then extracted from the retrieved policy documents using NLP techniques. The rules may include, but are not limited to, policy terms, benefit calculation formulae, etc. Each rule may include one or more data points whose values must be determined through analysis of the claim information and/or claim documents. Extraction of policy rules from original policy documents is discussed in more detail hereafter.

Alternatively or additionally, structured information regarding the applicable policies is also retrieved from the database. Such information may include previously extracted policy rules, including policy terms, benefit calculation formulae, data points, etc.

In step 316, the claim information is assessed and analyzed against the policy rules to determine eligibility and applicable benefits. In some cases, the retrieved or extracted policy rules may identify one or more data points (including benefit conditions) that need to be determined based on claim information. For example, a specific income protection policy may not be payable unless the claimant is under medical care, among other requirements. In this case, the system determines, using the received claim information, whether the claimant is under medical care.

In an embodiment, the system extracts information from received claim documents in order to determine values for the data points identified by the policy rules. Such extraction can include one or more Natural Language Processing (NLP) techniques. If a value for a required data point cannot be determined using the received claim information and documents, the system may flag the case manager that human intervention is needed to make a decision, e.g., to require additional documentation if necessary.

In step 320, the benefit is calculated based on the extracted terms, formulae, and calculated data points, including conditions. In an embodiment, for cases with policy upgrades (e.g., updates or a completely new version), the most favorable payment will be determined if required. This is accomplished by calculating payment amounts under each policy version, and then selecting the highest payment amount.

In step 324, the payment to the customer is made. In an embodiment, the payment may be reviewed by a case worker and/or manager prior to the payment being made. In this case, the proposed payment is automatically sent to the case manager for review and, upon approval, automatically sent to the customer. Any necessary reports can also be generated automatically.

FIG. 5 illustrates an example method 500 for receiving and processing claim type information (see FIG. 3 at 304). In an embodiment, method 500 may be implemented by the claim type determination engine 210.

In step 504, a new claim is initialized in the system if necessary. In step 508, any non-computer readable documents are converted to a computer-readable form, e.g., paper documents are scanned into the system (e.g., as PDF files) and converted into text. The conversion may be aided by document metadata and document templates. The conversion may be performed by document conversion engine 250.

In step 512, the claim data can be extracted from the received claim documents by information extraction engine 230, using natural language processing (NLP) techniques.

In step 516, the claim type determination engine 210 then determines the claim type, e.g, total and permanent disability, life insurance death benefit, trauma benefit, workers compensation, etc., based on claim information or a trained machine learning prediction model. If a prediction model is used, it can be previously trained using some historical claim data as the input and historical claim type data as the target.

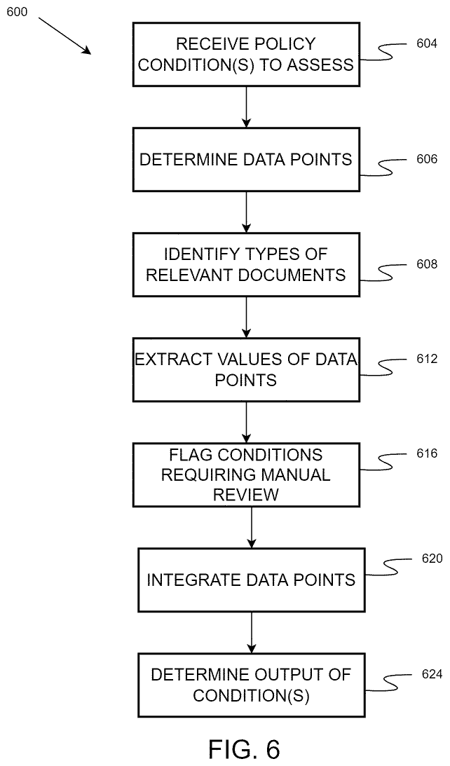

FIG. 6 illustrates an example method 600 for assessing and analyzing claim data point information against the policy, for example, to assess a given policy condition (see FIG. 3 at 316). Method 600 may be implemented by the benefit eligibility assessment engine 270 and the data point engine 220.

One or more benefit conditions that need to be calculated are determined based on the policy rules retrieved at step 312. For example, with respect to a total disability benefit of a workers' compensation or income protection plan, such benefit conditions may include, but are not limited to, whether the claimant is under medical care, the incurred date of the incident giving rise to the claim, whether the claimant is capable to work in his or her occupation, whether the claimant is capable to work in any occupation, whether the claimant is experiencing sickness or injury, whether the claimant is currently employed, how long the claimant has been covered, and many more. In step 604 one or more of these conditions are provided and in the next steps the method assesses if the conditions are met based on extracted data points.

In step 606, one or more data points that need to be calculated are determined based on the policy conditions or rules retrieved at step 312. With respect to a total disability benefit of a workers' compensation or income protection plan, such data points may include, but are not limited to, type of plan, plan start date, plan benefit amounts, the existence and amount of any offsets, applicable policy changes that benefit the claimant (e.g, upgrades), the claimant's pre-disability income, ancillary benefits, employment type (e.g., self-employed or regular employee), occupation type, length of time unemployed, claim incurred date, whether the claimant is capable of working in his or her occupation, whether the claimant is capable of performing any occupation for which he or she is reasonably suited, whether the claimant is working in any occupation, whether the claimant is under medical care, claimant age, proof of income, etc.

Other data points may be needed to determine eligibility for a claim and to calculate a claimed benefit, and one of ordinary skill in the art will be able to readily identify such data points.

In step 608, one or more documents that may include information helpful in determining the value of each benefit condition and data point are identified. The system stores a correlation between the benefit conditions and data points and the documents that may contain information relevant to the variables.

The following examples apply to a workers' compensation or income protection plan. For an “under medical care” data point, relevant documents may include medical records, including doctors' medical opinions, transcripts of phone calls regarding the claim (e.g., between case managers and claimants), treatment reports, clinical notes, hospital records (e.g., discharge reports), etc.

For an “incurred date” condition or data point, relevant documents may include claim forms, doctors' medical opinions, clinical notes, transcripts of phone calls regarding the claim, transcripts of phone calls with the employer, etc.

For a “capable of working in one's occupation” condition, relevant documents may include doctors' medical opinions, case manager notes, occupational details forms, independent medical reviews, etc.

For a “capable of working in any occupation” condition, relevant documents may include doctors' medical opinions, transcripts of phone calls with regarding the claim (e.g., between case managers and claimants), treatment reports, clinical notes, hospital records, work capacity reports (including checklists), activity diaries, independent medical reviews, etc.

For a “sickness or injury” condition, relevant documents may include doctors' medical opinions and/or notes, hospital records, independent medical reviews, etc.

For an “offset” data point, relevant documents may include doctors' medical opinions, claim forms, workers compensation or other benefit receipts from other financial institutions paid in regards to the underlying injury or sickness, transcripts or notes from phone calls regarding the claim (e.g., between case managers and claimants), etc.

For a “pre-disability income” data point, relevant documents may include tax returns, business tax information, pay slips, etc.

In step 612, for each data point, if it is not already assigned a value (e.g., by the case manager), the system will attempt to determine its value by extracting the information (as described in more detail below) from available documents of the identified types.

In step 616, the claim is flagged for further review (e.g., by a case manager) under several different conditions, including but not limited to: 1) if none of the identified types of documents are available; 2) if a value for a data point cannot be determined from the available documents; 3) if the confidence score output of document converted using one of the techniques described herein is too low; 4) if multiple documents containing information relevant to the data point are available, and the information extracted from one such document contradicts information extracted from another such document; or 5) if a calculation needs to be verified, e.g., for certain pre-disability income calculations and other complex calculations that require specific domain knowledge.

If the claim is flagged for further review, the domain expert may request any additional documents necessary to calculate values for the missing data points or validate the calculations for some complex scenarios. In an embodiment, the system can automatically request the necessary documents and, when the documents are received, extract the information for the data point. Alternatively, the case manager may manually input values for the missing data points.

In step 620, the automatically generated data points and any manually input data points are merged into a final result.

In step 624, whether or not the condition is met is determined based on the data point values as compared against applicable policy rules.

Eligibility for other benefits under the policy, such as ancillary and/or included benefits, options, and offsets, can be determined by similar methods, as will be apparent to those of ordinary skill in the art. After the system has determined that the claimant satisfies the conditions for a benefit, the benefit is calculated based on the extracted terms, formulae, and data points. If any additional data points are necessary for the calculation, they are extracted from the claim documents as discussed herein.

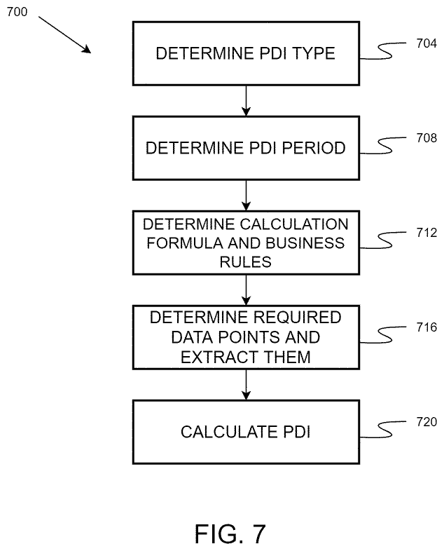

For some benefit types, such as total disability or partial disability, there are some components that need to be calculated first before the final benefit calculation. The components may include pre-disability income (PDI), offsets, etc. FIG. 7 illustrates an example method 700 for PDI calculation. Similar methods may be used to calculate other required components, e.g., offset amounts, partial disability monthly income, total disability benefits, etc.

In step 704, the PDI type, e.g., self-employed, regular employee or mixed, is determined based on the claim documents.

In step 708, the PDI period is determined based on the claim documents and the definition from each specific version of applicable policies.

In step 712, the PDI calculation formulas are determined from the policy documents as described herein and/or additional business rules.

In step 716, any necessary data points or variables are determined based on the calculation formulas and business rules. Any data points that are missing are extracted from the claim documents and/or a policy and customer database.

In step 720, the PDI is calculated. The calculated PDI may then be used in the calculation of the benefit amount.

As discussed herein, the system is able to automatically extract information from documents using document conversion engine 250 and information extraction engine 230. Information may be extracted in various ways, depending on the type of document and the specific information needed. Claim documents may include, but are not limited to, pdf documents (e.g., filled pdf forms, pdf text documents (including tax returns and policy documents), handwritten pdf documents, etc.), text documents, scanned images (e.g., of text documents, machine-typed documents, receipts, manually-filled out forms, and other handwritten documents, such as doctors' notes, etc.), program-generated images, audio and/or video recordings of phone and/or video calls, etc.

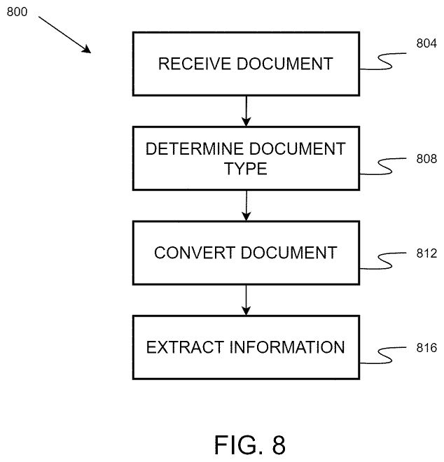

A method 800 for information retrieval is illustrated in FIG. 8. In step 804, a document is received. Metadata regarding the type of document (with respect to its contents, e.g., the document is a financial document, medical documents, etc.) may also be received.

In step 808, the format of the document (e.g., pdf, image file, etc.) is determined based on the filename extension or other methods.

In step 812, the document is converted to text using one or more techniques depending on its type. For example, pdf documents are converted to text and processed as a text document by the information extraction engine 230. Some pdfs in standard format may be directly converted to text using a pdf conversion package. In an embodiment, standard pdf documents that include tables may first be segregated into table-containing parts and other parts (e.g., through identification of table-related tags), and the parts converted to text separately. The tables may be converted into a text table format (e.g., a CSV file) using a table conversion package.

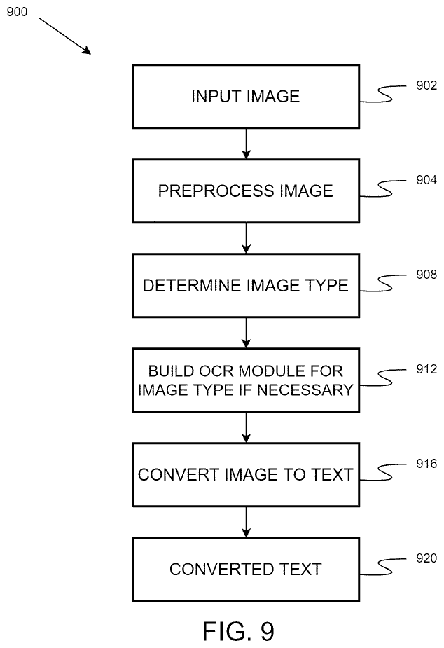

In cases where the pdf document is unable to be converted to text directly (e.g., the pdf does not follow pdf ISO or other standards, is a wrapper for images, etc.), the pdf may be transformed into one or more image files and processed as such. Conversion of image files is explained in more detail with respect to FIG. 9 below.

In step 816, the needed information is extracted from the converted document using natural language processing (NLP), including text normalization (e.g., converting to a consistent case, removing stop words, lemmatizing, stemming, etc.), keyword recognition, part of speech tagging, named entity recognition (NER), sentence parsing, regular expression searching, word chunk searching (e.g., using a context-free grammar (CFG)), similarity searching (e.g., with word/sentence embedding), machine learning models, transfer learning, question and answering systems, etc.

The document conversion engine 250 is also configured to convert image files to text. A method for converting images of text (either handwritten or machine-typed) into text is illustrated in FIG. 9. Any image file format (e.g., jpeg, png, gif, bmp, tiff, etc.), including image file formats that will be created in the future, may be converted using this method.

Image files documents may be generally divided into several categories: 1) image files consisting of machine-printed or machine-typed text; 2) image files consisting of hand-written text; and 3) image files with both. Form-like documents, which include machine-printed text and handwritten text, generally in a Q&A format with tables and/or boxes, are a subset of category 3.

In step 902, an input image is received.

In step 904, images that have sufficient clarity may be preprocessed, using techniques including skew correction, removal of black boxes, sharpening filters, enhancement of font and/or resolution, perspective transformation, noise removal, and/or morphological transformations (e.g., dilation, erosion, opening, closing, etc.) to better identify segments of text. Additionally, the blurriness of the images may be determined, and images that are too blurry to be processed further may be flagged for manual review

In step 908, the type of image is determined, e.g., if the image is solely machine-typed text, solely handwritten text, or a combination. In an embodiment, a deep learning classifier may be used to initially classify image files into one of the categories. Alternatively, such classification may be performed manually.

Some documents with a combination of machine-typed text and handwritten text will be form-like documents, and these can be distinguished from other combination documents using heuristics or a trained machine learning model. One example of such a heuristic involves quantifying the distance between the machine-typed text lines and the spacing between handwritten lines. In a form-type hybrid document, the spaces between the machine-typed text lines are consistent or follows a pattern because the machine-typed questions are often equally spaced. Also, machine-typed text is usually of a consistent font size, so even if lines aren't equally spaced, the spacing is approximately a multiple of a consistent line height. In contrast, spacing between handwritten lines is generally inconsistent.

In step 912, any needed OCR modules for the types of images can be built if necessary. For example, a deep learning model for handwriting recognition can be trained. In an embodiment, this model may comprise a convolutional neural network (CNN) connected to a recurrent neural network (RNN), which is in turn connected to a connectionist temporal classification (CTC) scoring function.

Documents that include both machine-typed text and handwritten text, e.g., manually filled-out forms, are commonly used in many industries. Such forms often include a series of questions or other machine-typed labels for needed information, and spaces in which to write the supplied information. To automatically process such a form, the document conversion engine 250 uses a text classifier that recognizes typed and handwritten text in a mixed image. In an embodiment, the classifier is a trained deep learning model that classifies text lines into machine-printed text lines and handwritten text lines. In a particular embodiment, the deep learning model may comprise a convolutional recurrent neural network. The model may be trained on labeled printed and handwritten text lines.

In an embodiment, an integrated OCR may be generated using the handwriting recognition model, the text classifier, and a machine-typed OCR module, which is able to process all the different types of text.

In step 916, the images are processed using one or more of the OCR modules to generate converted text 920. The resulting text can then be processed by the information extraction engine 230.

For the images that are converted to text format, positional relationships between the original image of the text and the converted text are also stored. For example, the original location of each text segment in the document may be stored (e.g., using x and y coordinates) along with the converted text. This enables proximity and/or context information to be used by the information extraction engine when extracting needed information from the document.

In an embodiment, image files may be segmented into regions, and one or more regions of interest (ROI) can be selected. Then only the ROIs are converted to text to be used for information extraction.

If the image is unable to be converted to text, e.g., it is unreadable due to bad quality, it is overly blurry, etc., the document is flagged for review by a case manager and the image is identified for manual retrieval by the case manager. In an embodiment, the problematic portions of the image are highlighted.

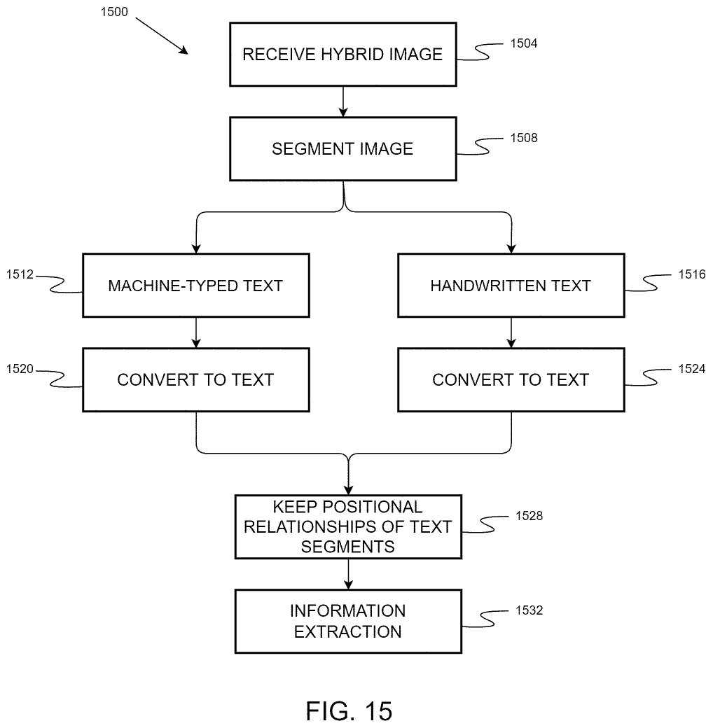

A method 1500 for converting hybrid type-written and handwritten documents to text is illustrated in FIG. 15. In step 1504, a hybrid document is received. In step 1508, the document is divided in segments of machine-typed text 1512 and handwritten text 1516 using a machine learning classification model. Each word and/or element on the page is associated with words and elements within a specified proximity based on the position and the dimensions of the word or element on the page and the distance to surrounding words and/or elements. Each collection of words and/or elements can be considered an individual segment.

The original location of the segment in the document (e.g., the X/Y coordinates of the segment with respect to an origin point of the document) is also associated with each segment.

In step 1520, each machine-typed text segment is converted into text format using OCR techniques.

In step 1524, each handwritten text segment is converted into text format using a trained handwriting conversion model.

In step 1528, the positional relationships of the segments with respect to each other is maintained, e.g., by replacing each segment in the document with the extracted text to create a final document where all of the machine-typed and handwritten text has been converted to text.

In step 1532, any needed information is extracted from the converted document.

After the document(s) is converted to text, the information extraction engine 230 uses NLP techniques to extract the needed information. Such techniques may include text normalization (e.g., converting to a consistent case, removing stop words, lemmatizing, stemming, etc.), keyword recognition, part of speech tagging, named entity recognition (NER), sentence parsing, regular expression searching, word chunk searching (e.g., using a context-free grammar (CFG)), similarity searching (e.g., with word/sentence embedding), machine learning models, transfer learning, question and answering systems, etc.

For example, in an image document with form format, the words of the questions (or other labels) may be parsed using NLP techniques to identify where in the form the needed information may be found.

After the location of the question (or label) for the needed information is identified, the location of the answer is determined. This will generally in proximity to the question or label, e.g., for forms, it will generally be underneath the question (or label) or to the right of the question. The stored line locations (e.g., x and y coordinates) can be used to identify lines of text in close proximity to the question or label, as such lines are more likely to include the information for the data point. In some instances, the lines containing a possible answer will be underlined, or surrounded by a box. The converted text of the lines in proximity may then be analyzed to determine the value of the data point.

For example, if a date is required, e.g., the date of injury, the incurred data, the date of a doctor's diagnosis, etc., words indicating a date may be identified in the form. Such words include, for example, ‘date’, ‘when’, etc. The type of date may also be identified via keywords such as ‘injury’ for date of injury, etc.

After it is determined that the needed date is in the document, the actual information, e.g., the value for the date, is identified using NLP techniques. Because the context of each line of text is saved (e.g., its position in the document), the system can search for dates in nearby text. For example, text in date format near the words indicating the date may be identified and used as the value of the data point.

For the “offset” data point, relevant key words include phrases that indicate workers' compensation, such as “workers compensation,” “W/C,” “WC,” “worker's comp,” “work injury,” “work accident,” “receive a payment,” “lump sum,” “payout,” etc.; phrases that indicate another insurance policy, such as “other life insurance,” “disability benefit,” “TPD,” “total and permanent disability,” “trauma,” names of other insurance companies, etc.; phrases that indicate the injury was due to an automobile accident, such as “MVA,” “motor vehicle accident,” “car accident,” etc.; and phrases that indicate a government benefit, such as “common law,” “center link,” “government benefit,” “social security,” etc.

For the “capable of working in any occupation” data point, relevant key words include “hospital,” etc. For the “sickness or injury” data point, relevant key words include words related to sickness, e.g., “cancer,” “stroke,” “diabetes,” etc. and words related to injury, e.g., “fracture,” names of specific body parts, etc.

In an embodiment, prior to being analyzed by the information extraction engine, documents may be classified by category, e.g., medical documents, financial documents, employment documents, miscellaneous documents, etc. The specific type of document may also be determined, e.g., 1040 tax form, etc. NLP techniques tailored to the document category or type may be used to extract the required information from the documents.

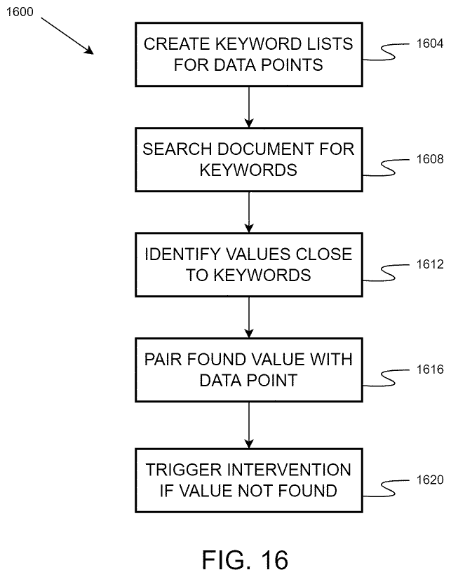

An example method 1600 for extracting financial data from a financial document (e.g., a paystub, a profit and loss statement, etc.) is illustrated in FIG. 16. In step 1604, a keyword list is created for each needed financial data point. Financial documents tend to have a fixed structure and format, so this method works well for such documents. The keyword list includes the possible keywords that indicate the potential presence of the data for the data point. The keyword list may also include one or more specific positions where that keyword may be found in a particular type of document, such as a tax form, and the relative positioning of the value for the data point as compared to the position of the keyword. For example, in a particular tax form, the filer's income will typically be proximate to, or in a known positional relationship from, the keyword “income.” As such, the keyword list may include “income”, as well as the expected position in the document of the keyword, and the expected position in the document for the corresponding income value.

In step 1608, the document text is searched for the keywords in the list.

In step 1612, document text in proximity to the keywords is searched for possible values for the associated data point. Proximity is determined based on the position information that is saved during the conversion of the document to text. Financial documents tend to have a fixed format, so if a keyword is found in a particular expected position in the document, the corresponding value for the data point associated with the keyword may also be located using the expected positional relationship (as determined in step 1604) between the keyword and the corresponding value.

In step 1616, if a single value is found in the previous step, it is saved as the value for the data point variable.

In step 1620, if a single value was not found, human intervention is triggered to determine the value for the data point. If multiple possible values for the data point were found in step 1616, the values may be presented to a case manager for selection of the correct value.

Though this method is especially suitable for financial documents, this method can be used for extracting information from other types of documents, including medical documents, miscellaneous documents, etc.

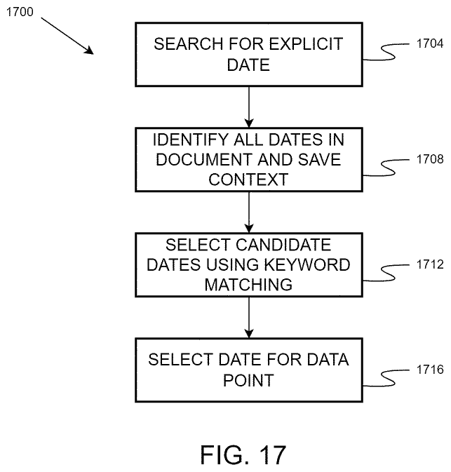

An example method 1700 for extracting date information from a document (e.g., a cease work date, an incurred date, etc.) is illustrated in FIG. 17. In step 1704, specific keywords that explicitly identify the date are searched for in the document. If found, the date or date range closest in proximity to the found keyword(s) is saved as the value for the data point. A date range may be identified by matching a pattern such as “from * to *”, where the *'s are dates.

In step 1708, if the date(s) is not found by keyword matching, all dates in the document are identified and the textual context of each date is saved. In an embodiment, the textual context is about 10 words before and after the date. The textual context will also include any labels for the date.

In step 1712, for each date in the document, a list of keywords associated with the data point is compared with the textual context of the date, and the dates that match a sufficient number of the keywords are kept as candidate dates.

In step 1716, one date is selected as the value for the data point. Each date in the candidate date list is checked using a pre-set rule to determine if it should be selected. For example, when initiating a total or partial disability claim, the claimant will have entered a date when he or she ceased work, but this date is not verified or supported by medical evidence at this point. If any date in the candidate list matches the previously entered date, it will be selected as the best candidate date. Some important data points, such as the incurred date, will always be reviewed by a case manager, but others may not be.

This method can be used to extract date information from any type of document, including financial documents, medical documents, miscellaneous documents, etc.

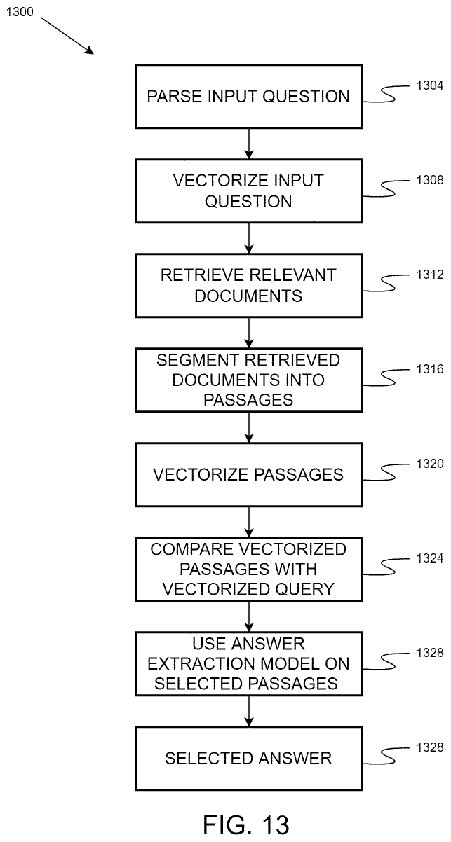

A method for information retrieval and/or extraction using a question and answer framework is illustrated in FIG. 13. The method 1300 takes a predefined input question crafted for the required data point and a collection of text documents from which to extract the data point required to answer the question. The method comprises four main phases: 1) query processing; 2) document retrieval; 3) passage retrieval; and 4) answer extraction, which leads to an output answer.

In step 1304, the input question is parsed to identify the most relevant keywords. The words of the question may be compared to a list of predefined keywords, and matches may be saved for further processing. Additionally and/or alternatively, the question may be processed by removing stop words and particular parts of speech, leaving only the most important words of the query. In an embodiment, only proper nouns, nouns, numbers, verbs, and adjectives are kept from the original query.

In step 1308, the modified query (e.g., the selected keywords from the query) is converted into a vector for use later in the process.

In step 1312, documents that may contain the answer to the original question are retrieved from the document store. In an embodiment, keyword matching between the query keywords and the words of the documents may be used to identify relevant documents, though other techniques for identifying relevant documents will be recognized by one of ordinary skill in the art.

In step 1316, the retrieved documents are segmented into passages (a passage is a shorter section of a document) for faster processing. This can be performed by a trained passage model or defined segmentation rules.

In step 1320, the passages are converted to vectors, similar to how the query is converted to a vector in step 1308.

In step 1324, the vectorized passages are compared to the vectorized query using cosine similarity or another similarity measure. The passage(s) with the highest similarity score(s), or the passages with a similarity score higher than a threshold score, may be selected for further processing in the next step.

In step 1328, each passage selected in the prior step is input into an answer extraction model, such as BERT (Bidirectional Encoder Representations from Transformers), ALBERT (A Lite BERT), ELECTRA, RoBERTa (Robustly Optimized BERT Pre-training Approach), XLNet, bio-BERT, a medical language model, etc., which gives the possible answers to the question, each with a corresponding confidence score. Then the answer with the highest score can be the final output 1332 of the method.

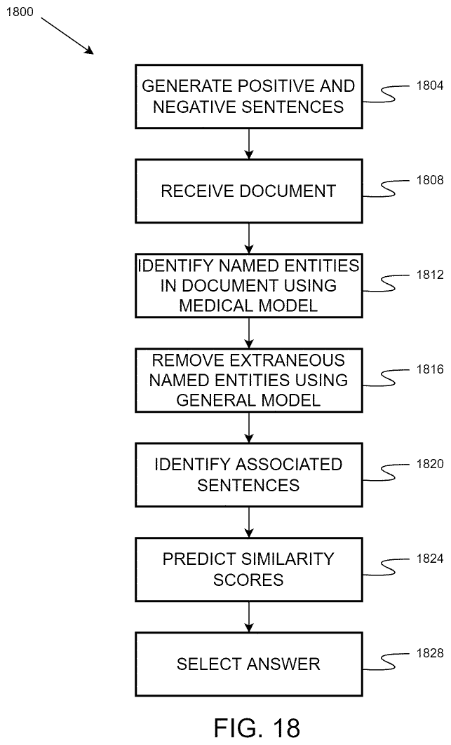

A method for information retrieval and/or extraction of medical information related to specific illnesses and injuries is illustrated in FIG. 18. Method 1800 starts by creating both positive and negative sentences related to the existence of a particular illness or injury in step 1804. For example, if the specific illness being searched for is a heart attack, the sentences can be “the patient had a heart attack” or “the patient didn't have a heart attack.” Variations on the sentences can also be created, e.g, “the man/woman had a heart attack”, “the patient is having a heart attack”, etc.

In step 1808, a medical document is received.

In step 1812, a pre-trained medical/clinical named entity recognition (NER) model is used to identify words in the medical document that relate to a known named medical-related term. This step can return many irrelevant results, such as proper names and places, so in step 1816, a pre-trained general NER model is used to remove these irrelevant results, leaving only the specific medical terms recognized by the medical NER model but not recognized by the general NER.

In step 1820, the complete sentences that contain the words identified in steps 1812 and 1816 are extracted from the document using NLP techniques.

In step 1824, similarity scores between the sentences created in step 1804 and the sentences extracted from the document are created using the method disclosed in FIG. 13.

In step 1828, the sentence from the document with the highest score is selected as the answer. If the selected sentence is most similar to the positive sentence, then the claimant has or had the condition. If the selected sentence is most similar to the negative sentence, then the claimant does not have or did not have the condition. This result is then saved for further processing according to the methods disclosed herein.

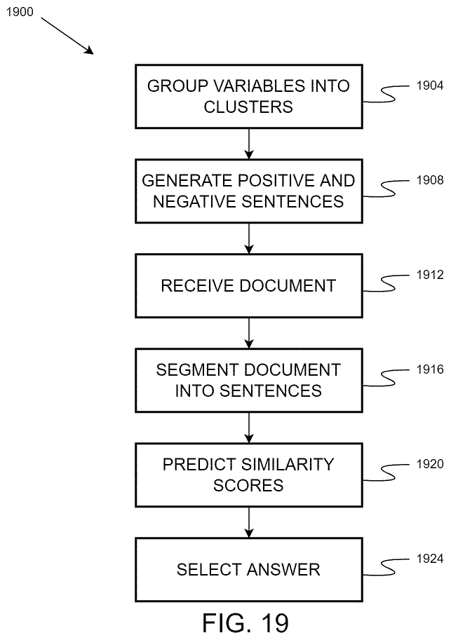

Another method for information retrieval and/or extraction of medical information, this one more useful for extracting the answers to more general questions, is illustrated in FIG. 19. Method 1900 starts by clustering medical-related data points or variables into clusters of similar data points in step 1904. For example, all of the work-related data points, such as if the claimant is capable of work in his/her field, if the claimant is capable of any work, etc., can be grouped into a single cluster.

Positive and negative sentences related to the data point cluster are created in step 1908. For example, if the specific data point being searched for is a whether the claimant is capable of work, the sentences can be “the patient is capable of work” or “the patient isn't capable of work.” Variations on the sentences can also be created, e.g, “the man/woman is capable of work”, “the patient wasn't capable of work”, etc.

In step 1912, a medical document is received.

In step 1916, the document is segmented into sentences.

In step 1920, similarity scores between the sentences created in step 1908 and the document sentences are created using the method disclosed in FIG. 13.

In step 1924, the sentence from the document with the highest score is selected as the answer. This result is then saved for further processing according to the methods disclosed herein.

Any information extracted from a document using any of the techniques disclosed herein may be associated with a date, e.g., the date of the document, so that the extracted information can be considered valid for only a specific date period.

In an embodiment, after information is extracted from the claim documents, the information is aggregated to the claim level to be used as the final result for benefit assessment.

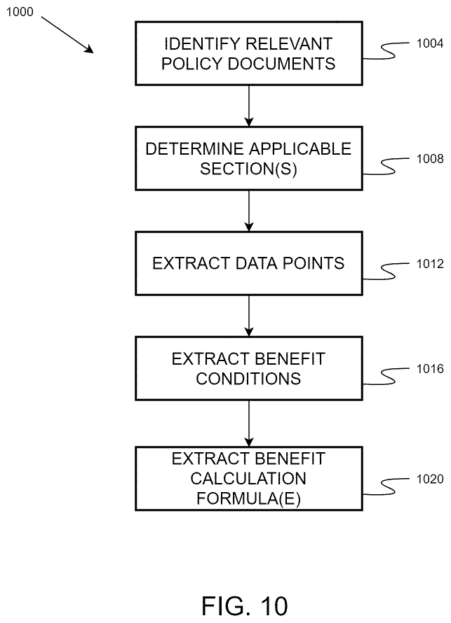

FIG. 10 illustrates an example method 1000 for extracting policy rules from policy documents, as may be implemented by policy rule extraction engine 260. In step 1004, policy documents relevant to the submitted claim are located. In an embodiment, an index or table may be used to look up the applicable documents based on claim information, such as claim type, incurred date, occupation code, basic policy information etc. The following steps are performed for each identified policy document.

In step 1008, the applicable section of the policy document, based on the claim type, is determined. In an embodiment where policy documents are structured into sections with headings, the system may locate the applicable section of the policy based on the textual content of the headings. For example, if the policy document includes sections with headings including the terms “Total disability” and “Partial disability”, the system identifies the “Total disability” section as containing the relevant policy clauses to determine if a claim is entitled a the “Total Disability” benefit.

Similarly, in an embodiment where policy documents include a table of contents, the chapter titles may provide context clues for which chapters are applicable. Policy documents may include both a table of contents and section headings, and in such cases, both may be used to identify the applicable section(s).

In step 1012, required data points and data types of each data point are determined based on the individual clauses of the identified section of the policy document. Such data points may include pre-disability income (PDI), offset amounts, medical status (e.g., whether under medical care), working status, claimant's capability of doing work, type of plan, etc.

For example, an example policy clause may read:
We will pay up to $100 per day for up to 90 days for each day the immediate family member has to stay away from home after the end of the waiting period.

The policy rules extraction engine is able to parse this clause to identify several important data points, including: 1) per diem amount (e.g., $100); 2) maximum time period (e.g., 90 days); 3) qualified payee (e.g., immediate family member); and 4) qualified action (e.g., stay away from home). In clauses where a maximum payable amount is used instead of a maximum time period, the maximum payable amount is identified.

The policy rules extraction engine uses NLP techniques to parse the clause, including key word recognition, part of speech tagging, word chunking, etc. For example, key words that indicate a per diem amount include “per day,” etc.

In another example, the text of the policy document may recite:
The person insured is totally disabled if, because of an injury or sickness, he or she is: 1) not capable of doing the important duties of his or her occupation; 2) not working in any occupation (whether paid or unpaid); and 3) under medical care.

The system uses NLP techniques to parse this clause and determine 4 requirements for a benefit: 1) the claimant is not capable of doing the important duties of his or her occupation; 2) this condition is because of an injury or sickness; 3) the claimant is not working in any occupation; and 4) the claimant is under medical care.

For example, the system can determine that the requirement of “injury or sickness” exists because of the presence of the keywords “injury” and/or “sickness” in the clause. Similarly, “under medical care” indicates the requirement of being under medical care, “not working” indicates the requirement of not working in any occupation, and “not capable” indicates the requirement of not being capable of doing the important duties of his or her occupation.

In step 1016, benefit conditions are determined based on the individual clauses of the identified section of the policy document. Benefit conditions may include one or more of the required data points identified in step 1012. Such conditions include, but are not limited to, whether the claimant is under medical care, the claimant's occupation, the claimant's ability to work in his or her regular occupation, the claimant's ability to work in any occupation, whether the claimant is currently working in any occupation, and whether the claimant's condition is because of injury or sickness.

In step 1020, the benefits, including formulas to calculate benefits, fixed benefit amounts, etc., are extracted from the identified section of the policy document using similar NLP techniques.

In an embodiment, instead of extracting information from policy documents each time a claim is processed, policy documents may be preprocessed for each policy document relevant to a claim type, and a lookup table generated that creates a correspondence between claim types and policy rules, conditions, data points, etc.

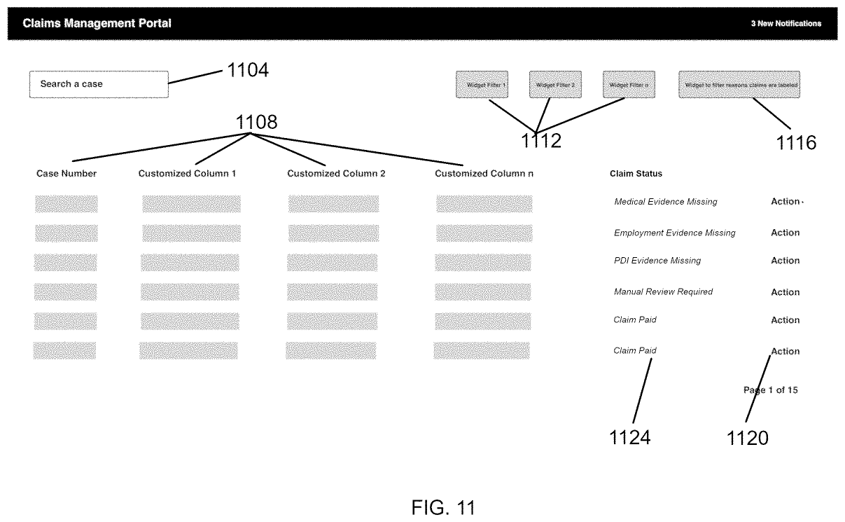

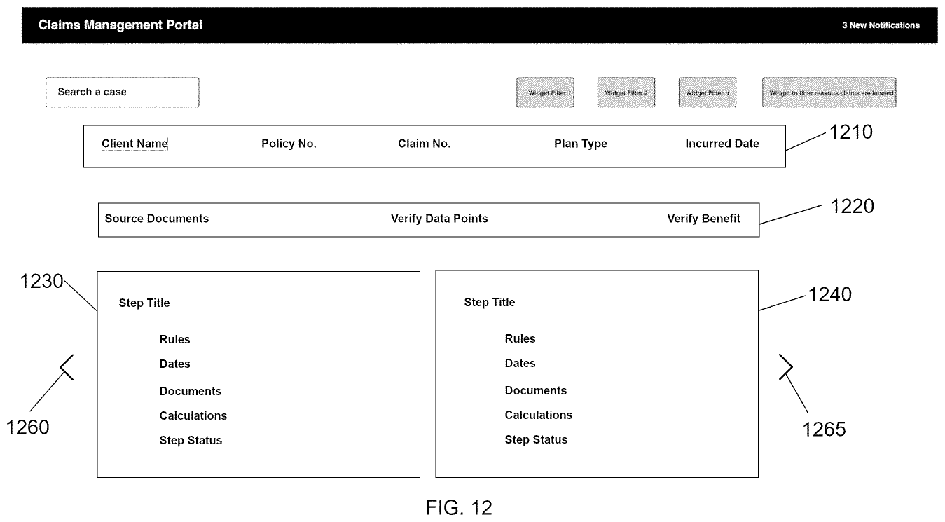

FIGS. 11-12 illustrate an example interface for case (e.g., claims and claimants) management. As shown in FIG. 11, a case summary screen includes a case search box 1104, columns 1108 for displaying different aspects of each case (e.g., case number, etc.), widgets 1112 for filtering the displayed cases, widget 1116 for filtering displayed claims based on the ‘claim status’ field, and action buttons 1120. Claim status column 1124 identifies the status of each claim, e.g, if a claim has been paid, if additional documentation is required (e.g., medical, financial, etc.), if manual review by a case manager is required, etc. The system flags a claim for manual review under certain conditions (which are flexible and based on the type of claim), e.g., data point engine 220 cannot calculate a necessary data point, an exception is encountered (e.g., necessary medical or financial information to assess a claim's benefit type or calculate the benefit amount is missing, a handwritten document cannot be converted to text or a conversion to text has too low of a confidence score, etc.), a calculation requires verification (e.g., certain pre-disability income calculations, complex cases that require specific domain knowledge), an action needs to be taken (e.g., a claim payment is due in X days, a waiting period is due in Y days, etc.), etc. If an action button 1120 is selected, a drill down window for the corresponding claim is shown.

FIG. 12 illustrates an example drill down window after an action button is selected. As illustrated, a drill down screen includes a claim information panel 1210, a progress panel 1220, and one or more detail panels 1230 and 1240. The claim information panel 1210 includes information about the claim, such as the client name, the client's policy number, the claim number, and the claim incurred date. The progress panel 1220 shows which steps in the claim management process have been successfully completed, e.g., by changing the color of the progress text (e.g., source documents, verify data points, verify benefit, etc.).

Detail panels provide more information about a currently selected claim management step. As shown in FIG. 12, multiple detail panels are shown, but one or more detail panels may be displayed, depending on the amount of information that needs to be displayed to the user. Arrows 1260 and 1265 allow the case manager to move back and forth between claim management steps.

Inside each claim detail panel, information about a claim step is displayed. Such information may include the name or purpose of the step, a link to applicable definitions related to the step, a link to all applicable documents related to the step, an indication for whether the step has been completed, and any amounts for the step. For example, for an “incurred date” step, the definition (from applicable policy documents), a link to documents from which the incurred date was calculated (e.g., a doctor's opinion), and a calculated date may be displayed in a claim detail panel.

Similarly, for a “pre-disability income” step, the pre-disability income period (e.g., the period based on which the PDI is calculated), a link to documents from which the PDI was calculated (e.g., tax returns), and the calculated PDI may be displayed in a claim detail panel. For an “applicable policy documents” step, a link to all applicable policy documents (e.g., between at least the effective date of the policy and the incurred date) may be displayed in a claim detail panel. Other steps (e.g., “ancillary benefit,” “optional benefit,” basic benefit type,” “offset detection,” “total disability benefit amount, “subtract offset amount,” etc.) may display appropriate definitions (or links to definitions), applicable dates, applicable documents, and calculated amounts and/or conditions.

The disclosed methods, systems, and interfaces enable a claim management system that provides immediate access to all relevant documents related to a claim, so that claims can be calculated with higher accuracy, and the underlying documents can be more easily accessed when necessary for e.g., regulatory requirements, audits, customer inquiries, etc.

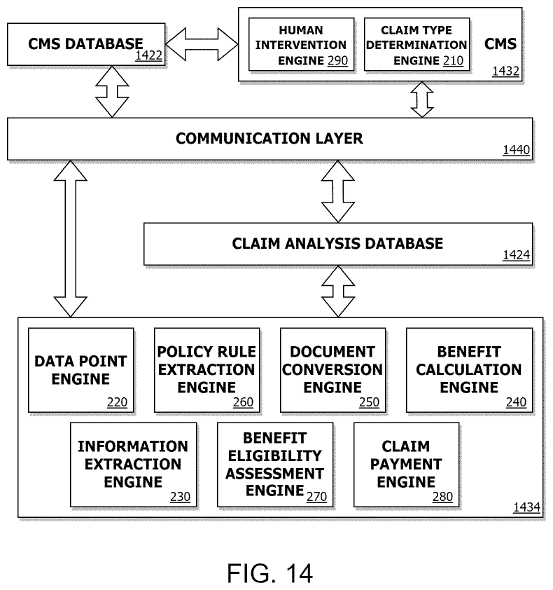

In some embodiments, the functionality of the system, modules, engines, and/or models may be distributed across multiple physical servers and/or devices in communication with each other, e.g., via API calls, etc. An example of such an embodiment is illustrated in FIG. 14. As shown, in this example embodiment customer/claim management system (CMS) 1432, and associated database 1422 are in communication with (via communication layer 1440) claim analysis system 1434 and associated database 1424.

CMS 1432 provides customer-facing and customer service representative-facing functionality, e.g., customer on-boarding and retention, policy renewals, claim submission, customer information retrieval and display, etc. In the illustrated embodiment, the CMS also includes claim type determination engine 210 and the human intervention engine 290. Claim analysis system 1434 includes data point engine 220, information extraction engine 230, benefit calculation engine 240, document conversion engine 250, policy rule extraction engine 260, benefit eligibility assessment engine 270, and claim payment engine 280, and is configured to provide benefit eligibility, calculation, and payment functionality for specific claim types.

CMS database 1422 stores information about customers, customer policies, customer interactions with customer service representatives, customer claims, etc. Claim analysis database 1424 stores documents received from CMS 1432; documents converted by document conversion engine 250; information extracted by information extraction engine 230; customer policy information extracted from policy documents by policy rule extraction engine 260; determinations made by benefit eligibility assessment engine 270, data point engine 220, and benefit calculation engine 240; and information about claim payments generated by claim payment engine 280.

Communication layer 1440 includes any communication protocols, APIs, etc., that are used for communication between the distributed systems. This layer includes, but is not limited to, standard HTTP requests and corresponding responses, pre-defined data schema for all modules and engines (both input and output), any data points and values to be sent across, etc.

In operation, when a claim is received by CMS 1432, the type of claim is determined by claim type determination engine 210, and if it is the type of claim handled by claim analysis system 1434, information about the claim is sent to the claim analysis system via the communication layer. The claim analysis system then processes the claim, interfacing with the CMS 1432 as necessary to retrieve documents and other information about the claim. The results of the claim processing, including eligibility determination and calculated benefits and payments, are sent back to the CMS. If the claim analysis system requires human intervention, such as when the value for a data point is unable to be determined, human intervention engine 290 is notified and the case manager is able to input the required data.

In alternative embodiments of a distributed system, one or more of the components of the CMS 1432 may be included in the claim analysis system 1434, and one or more of the components of the claim analysis system 1434 may be included in the CMS 1432. For example, the claim type determination engine 210 may be part of the claim analysis system. Additionally, any of the components or engines may be distributed between the system.

In alternative embodiments of any of the systems disclosed herein, the information retrieval and extraction engines may use third party extraction services, e.g., as provided by Google, Amazon (AWS), etc., and provide a user interface for selection of an image document and the third-party service to use for extraction of information from that document.

The disclosed systems and methods have many additional use cases. An example additional use case is comparison of insurance policies and identification of similar insurance policies. After the benefit information (e.g., benefit conditions, data points, actual benefits, etc.) are extracted from the insurance policy documents, the benefit information of two policies may be compared. Both the extracted structured information and the policy text itself may be compared to make a determination as to how similar the policies are. The policy text may be compared using NLP similarity techniques (e.g., cosine similarity, etc.). Comparisons between an original policy and several alternative policies may be calculated to determine a closest match.

Claims may be reassessed each time new claim information is received. For example, with new claim information, the claimant may no longer qualify for total disability benefits, and instead may only qualify for partial disability. In such cases, the new claim information may be evaluated along with existing claim information to determine benefits for which the claimant is currently eligible.

Furthermore, whenever new claim information is received, any payments related to the period of time relevant to the new information are recalculated by benefit calculation engine 240 and payments adjusted by claim payment engine 280. In an embodiment, any inconsistencies between previously calculated payment amounts and recalculated amounts may raise a flag to be handled by a case manager, who can make arrangements to make additional payment(s) due to an underpayment or reduce future payment(s) due to an overpayment.

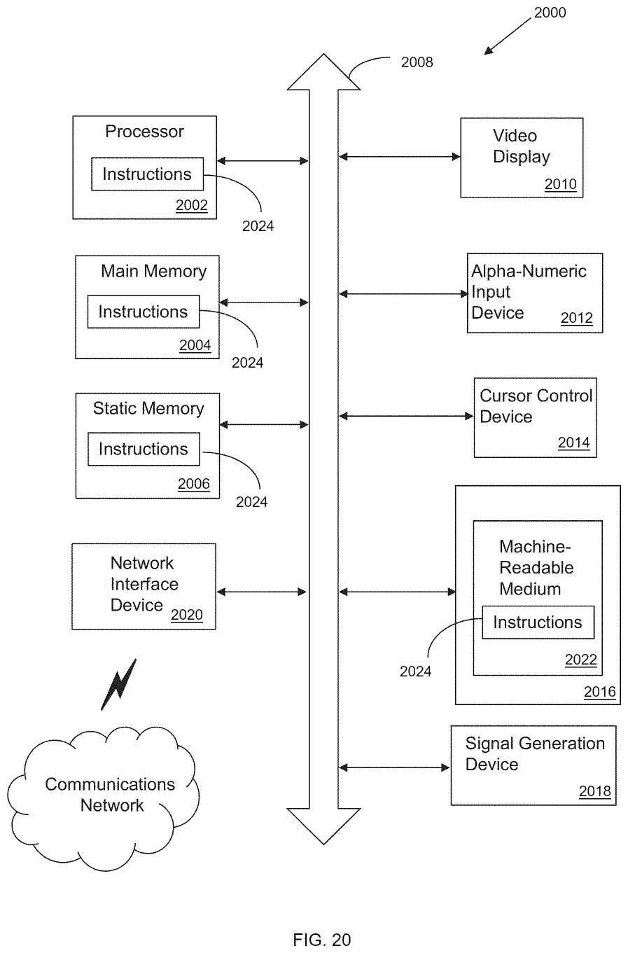

FIG. 20 is a schematic diagram of an example computing system for any of the systems described herein. At least a portion of the methodologies and techniques described with respect to the exemplary embodiments of the systems described herein may incorporate a machine, such as, but not limited to, computer system 2000, or other computing device within which a set of instructions, when executed, may cause the machine to perform any one or more of the methodologies or functions discussed herein. The machine may be configured to facilitate various operations conducted by the systems.

In some examples, the machine may operate as a standalone device. In some examples, the machine may be connected (e.g., using a communications network) to and assist with operations performed by other machines and systems. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 2000 may include a processor 2002 (e.g., a central processing unit (CPU), a graphics processing unit (GPU, or both), a main memory 2004 and a static memory 2006, which communicate with each other via a bus 2008. The computer system may further include a video display unit 2010, which may be, but is not limited to, a liquid crystal display (LCD), a flat panel, a solid state display, or a cathode ray tube (CRT). The computer system may include an input device 2012, such as, but not limited to, a keyboard, a cursor control device 2014, such as, but not limited to, a mouse, a disk drive unit 2016, a signal generation device 2018, such as, but not limited to, a speaker or remote control, and a network interface device 2020.

The disk drive unit 2016 may include a machine-readable medium 2022 on which is stored one or more sets of instructions 2024, such as, but not limited to, software embodying any one or more of the methodologies or functions described herein, including those methods illustrated above. The instructions 2024 may also reside, completely or at least partially, within the main memory 2004, the static memory 2006, or within the processor 2002, or a combination thereof, during execution thereof by the computer system 2000. The main memory 2004 and the processor 2002 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various examples of the present disclosure, the methods described herein are intended for operation as software programs running on a computer processor. Furthermore, software implementations can include, but not limited to, distributed processing or component/object distributed processing, parallel processing, or virtual machine processing, which can also be constructed to implement the methods described herein.

The present disclosure contemplates a machine-readable medium 2022 containing instructions 2024 so that a device connected to a communications network can send or receive voice, video or data, and communicate over the communications network using the instructions. The instructions may further be transmitted or received over the communications network via the network interface device 2020.

While the machine-readable medium 2022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

This specification has been written with reference to various non-limiting and non-exhaustive embodiments or examples. However, it will be recognized by persons having ordinary skill in the art that various substitutions, modifications, or combinations of any of the disclosed embodiments or examples (or portions thereof) may be made within the scope of this specification. Thus, it is contemplated and understood that this specification supports additional embodiments or examples not expressly set forth in this specification. Such embodiments or examples may be obtained, for example, by combining, modifying, or reorganizing any of the disclosed steps, components, elements, features, aspects, characteristics, limitations, and the like, of the various non-limiting and non-exhaustive embodiments or examples described in this specification.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. A method for analyzing a claim made by a claimant, the method comprising:
receiving claimant information, claim information, at least one claim document, and at least one policy document from a CMS;
extracting at least one policy rule from the at least one policy document;
determining at least one claim variable based on the at least one policy rule;
identifying at least one claim document likely to have information relevant to the at least one claim variable;
extracting the relevant information from the at least one claim document;
determining a value for the at least one claim variable based on the extracted information;
assessing if the claimant is entitled to the claim based on the determined value for the at least one claim variable;
calculating a benefit due the claimant; and
notifying the CMS of the claim assessment and calculated claim benefit.

2. The method of claim 1, wherein the extraction of the at least one policy rule from the policy document comprises the following steps:
identifying applicable sections of the policy document based on the content of the policy document and the received claim information;
extracting at least one necessary data point from at least one of the identified sections;
extracting at least one benefit condition from at least one of the identified sections; and
extracting at least one benefit based on at least one of the identified sections.

3. The method of claim 1, further comprising notifying the CMS when the value for the at least one claim variable is unable to be calculated or determined.

4. The method of claim 1, wherein the extraction of the relevant information comprises converting a document to text.

5. The method of claim 4, wherein the conversion of the document to text comprises the following:
preprocessing the document to improve document quality;
segmenting the document;
classifying each segment as either handwritten or machine-typed; and
processing each segment through an applicable conversion model.

6. The method of claim 5, wherein a trained handwriting recognition model is used to convert handwritten text and an optical character recognition algorithm is used to convert machine-typed text.

7. The method of claim 1, wherein the extraction of the relevant information comprises using at least one NLP technique.

8. The method of claim 7, wherein the extraction of the relevant information comprises calculating at least one quantifiable metric that is associated with the confidence level of the extracted information.

9. The method of claim 8, wherein the extraction of the relevant information comprises automatically sending a notification requesting human intervention when the quantifiable metric is below a threshold.

10. The method of claim 7, wherein the at least one NLP technique used to extract the relevant information from the at least one claim document comprises keyword identification.

11. The method of claim 7, wherein the at least one NLP technique used to extract the relevant information from the at least one claim document comprises a question and answering system wherein the questions are generated based on a data point, and wherein the questions include both positive and negative sentences.

12. The method of claim 11, wherein the question and answering system is configured to perform the following steps:
receiving a question;
extracting keywords from the question;
converting the extracted keywords to a vector;
identifying relevant documents in a document store based on the extracted keywords;
splitting the relevant documents into passages;
vectorizing the passages;
comparing the vectorized question keywords to the vectorized passages to determine the passages that are the most similar to the question; and
using a language model to extract the answer from the most similar passage based on the question keywords.

13. The method of claim 12, wherein the vectorized question keywords is compared to the vectorized passages using a cosine similarity metric.

14. The method of claim 12, wherein the language model comprises BERT, ALBERT, ELECTRA, RoBERTa, XLNet, bio-BERT, or a medical language model.

15. The method of claim 7, wherein the at least one NLP technique is determined based on the type of document.

16. The method of claim 15, wherein the type of document is determined from document metadata.

17. The method of claim 16, wherein each document can be classified as one of: a medical document, a financial document, and a miscellaneous document.

18. The method of claim 1, wherein extracting the relevant information comprises consolidating multiple extraction results from separate documents related to a claim to a claim level extraction result.

19. The method of claim 1, where extracting the relevant information comprises associating the extracted information with a date, so that the extraction result is valid for a specific dated period.

20. The method of claim 1, wherein extracting the relevant information comprises using proximity information to extract the relevant information.

21. The method of claim 5, further comprising associating an original position in the document with each segment and joining the segments according to their original position after converting the segments to text.

22. The method of claim 1, further comprising re-determining the value for the at least one claim variable based on at least one new item of claim information.

23. The method of claim 1, wherein determining the value comprises using both structured and unstructured data.

24. A system comprising one or more processors and one or more storage devices storing instructions that when executed by the one or more processors cause the one or more processors to perform operations comprising:
receiving claimant information, claim information, at least one claim document, and at least one policy document from a CMS;
extracting at least one policy rule from the at least one policy document;
determining at least one claim variable based on the at least one policy rule;
identifying at least one claim document likely to have information relevant to the at least one claim variable;
extracting the relevant information from the at least one claim document;
determining a value for the at least one claim variable based on the extracted information;
assessing if the claimant is entitled to the claim based on the determined value for the at least one claim variable;
calculating a benefit due the claimant; and
notifying the CMS of the claim assessment and calculated claim benefit.

25. A computer program product encoded on one or more non-transitory computer storage media, the computer program product comprising instructions that when executed by one or more processing means cause the one or more processing means to perform operations comprising:
receiving claimant information, claim information, at least one claim document, and at least one policy document from a CMS;
extracting at least one policy rule from the at least one policy document;
determining at least one claim variable based on the at least one policy rule;
identifying at least one claim document likely to have information relevant to the at least one claim variable;
extracting the relevant information from the at least one claim document;
determining a value for the at least one claim variable based on the extracted information;
assessing if the claimant is entitled to the claim based on the determined value for the at least one claim variable;
calculating a benefit due the claimant; and
notifying the CMS of the claim assessment and calculated claim benefit.
